(19) United States
(12) Patent Application Publication
(10) Pub. No.: US 2008/0307526 A1
(43) Pub. Date: Dec. 11, 2008

(54) METHOD TO PERFORM BOTNET DETECTION

(75) Inventors: Yishin Chung, Palo Alto, CA (US); Ron Davidson, Palo Alto, CA (US); Ofer Doitel, Woodside, CA (US)

Correspondence Address: SCHWEGMAN, LUNDBERG & WOESSNER, P.A., P.O. BOX 2938, MINNEAPOLIS, MN, 55402, US

(73) Assignee: Mi5 Networks

(21) Appl. No.: 11/759,807

(22) Filed: Jun. 7, 2007

(51) Int. Cl. G08B 23/00

(52) U.S. Cl. 726/23

(57) ABSTRACT

A method and a system for monitoring network activities associated with a computer connected to a network are provided. The method may include detecting a bot activity associated with the computer; attributing a bot status to the computer, based on a bot activity type associated with the bot activity, prior detections of bot activities, and considering time stamps. The method may also include updating the bot status attributed to the computer, based upon detection of subsequent bot activities associated with the computer, the bot activity types associated with the subsequent bot activities, and one or more other criteria. In one example embodiment, the network activities may include network transmissions and behavioral patterns. According to example embodiments, the system may include a network monitor, a bot activity detection module, a bot status module, and a bot status update module.

### TECHNICAL FIELD

Example embodiments relate generally to the technical field of network communications, and in one specific example, to detecting botnets.

### BACKGROUND

Bots, also known as web robots (or drowns, or zombies), may be computers or software applications that run automated, and/or remotely controlled tasks. Bots are often computers linked to a network that have been compromised by a security hacker, a computer virus or a Trojan horse. Bots can be part of a network called a botnet and participate in coordination and operation of various activities such as attack on network computers, generation of spam (sending e-mail spam without the owner's knowledge) or network scanning of other computers on the network.

With the increase in the use of the Internet and Local Area Networks (LAN), the issue of network monitoring, especially, detection of bots and their malicious activities in networks is turning into an important objective. Viable and effective methods for detecting network bots may be highly desired and could play a major role in network security.

### BRIEF DESCRIPTION OF THE DRAWINGS

Some embodiments are illustrated by way of example and not limitation in the figures of the accompanying drawings in which:

FIG. 1 is a high level diagram depicting an example embodiment of an Inline operation mode of a system for detecting botnets in a corporate LAN linked to the Internet;

FIG. 2 is a high level block diagram illustrating an example embodiment of an Port Span/Tap operation mode of a system for detecting botnets in a corporate LAN linked to the Internet;

FIG. 3 is a block diagram illustrating an example embodiment of a connection configuration and internal units of botnet detection system;

FIG. 4 is diagram illustrating example activity types of bot activities considered as typical characteristics of bot behavior;

FIG. 5 is a diagram illustrating an example embodiment of various modules of a botnet detection system.

FIG. 6 is a flow diagram illustrating an example embodiment of a method for network monitoring and botnet detection;

FIG. 7 is a state flow diagram illustrating an example embodiment of algorithm for defining various bot statuses and inter-status transitions;

FIG. 8 is a block diagram illustrating a diagrammatic representation of a machine in the example form of a computer system.

### DETAILED DESCRIPTION

Example methods and systems for monitoring network activities associated with a computer connected to a network have been described. In the following description, for purposes of explanation, numerous specific details are set forth in order to provide a thorough understanding of example embodiments. It will be evident, however, to one skilled in the art that the present invention may be practiced without these specific details.

For the purpose of present application, the term “Control and Command (C&C)” shall be taken to include, but not be limited to, a known botnet control node (e.g., a computer which has a command and control or other role in a botnet). The term “bot activity” shall be taken to include, but not be limited to, a type of activity detected by the botnet detection system which is considered typical characteristics of bot behavior. The term “bot status” shall be taken to include, but not be limited to, the current status of an inspected bot by the botnet detection system.

A method and system for monitoring network activities associated with a computer connected to a network are provided. One of the objectives of this application is to determine which one of the computers in a network may have been compromised and is involved in bot activities.

The example botnet detection in the present application may not be performed by scanning network computers or by inspecting files that may exist on those computers. Instead, the network traffic over time may be inspected; and based on algorithms described below, the bot status of a network computer may be decided. In other words, the example botnet detection in the context of this application may not require any agent software to run on a network computer to detect whether that computer is part of a botnet.

The method may include detecting a bot activity associated with the computer. In one example embodiment the method may include attributing a bot status to the computer, based on a bot activity type associated with the bot activity, prior detections of bot activities, and considering time stamps.

The method may also include updating the bot status attributed to the computer, based on detection of subsequent bot activities, the bot activity types associated with the subsequent bot activities, and one or more other criteria. In an example embodiment, the network may be (but not limited to) an internal network (e.g. an internal network of a business enterprise, a corporation, or a university).

According to example embodiments, the network activities may include network transmissions and network behavioral patterns (e.g. bot activities described below). The monitoring of the network activities may be performed from within the network, rather than by agents residing on the network computers. The method may further include recording of timestamps associated with the subsequent bot activities (e.g. times associated with instances of detection of subsequent bot activities).

In one example embodiment, the one or more other criteria may include the timestamp associated with the subsequent bot activities. According to example embodiments, the bot statuses may include suspect, active, inactive, or clean. An Active status may be attributed to a computer that is an active member of a botnet. A suspect status may be ascribed to a node that shows evidence of botnet activity, but there is not yet sufficient data to be certain that the node is an active bot. An inactive status may be the status of a computer that was active in the past but there is not any evidence of a recent bot activity in a predefined time window (e.g. for the last 5 days). A clean computer may be attributed to any computer with no evidence of past bot activity or no evidence of bot activity for another predefined longer time window (e.g., 90 days).

In an example embodiment, the bot activity types may include botnet control, Internet Protocol (IP) scanning, spamming, Distributed Denial of Service (DDoS) attack, and a spyware activity. According to example embodiments, botnet control may be an indication that the computer had a contact with a known botnet control node (e.g. a botnet C&C node). A network computer may be said to be engaged in IP scanning if there is evidence indicating that the computer is scanning other network computer via their IP addresses. In a spamming activity, the network computer may spam other computers or servers (e.g. by sending emails to a typically large number of mail servers). As for the DDoS activity, a computer engaged in such an activity may have attempted in a Denial of Service attack on a web server or other network computers. In such an attack, an attempt may be made to make a server or a network computer resources unavailable to their intended users.

In one example embodiment, updating the bot status attributed to a computer may be performed using a long-term memory algorithm (e.g., algorithms characterized by memory times of the order of magnitude of days, weeks or more). In an example embodiment, the behavioral patterns may include a behavioral pattern mixed with a signature (e.g., Internet Protocol (IP) address of a targeted computer may be compared with a list of IP addresses of known C&Cs. The IP address, in this case, may be considered as a signature).

### System Architecture

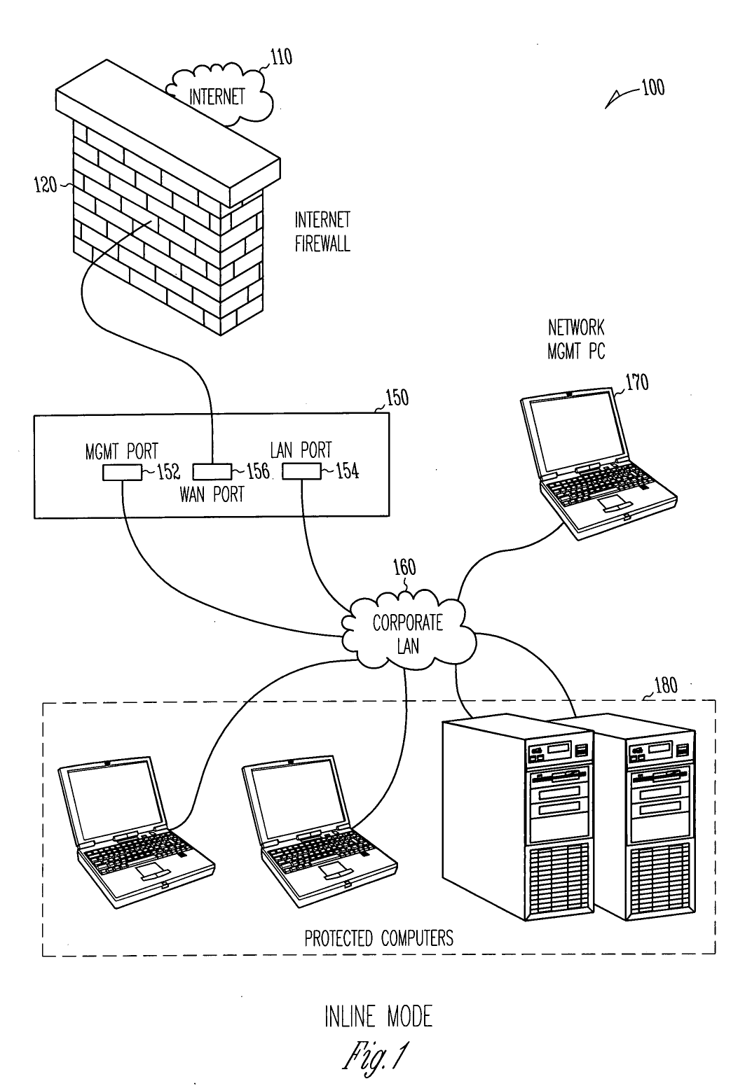

FIG. 1 is a high level diagram depicting an example embodiment of an Inline operation mode of a system 100 for detecting botnets in a corporate LAN linked to the Internet. The example system 100 may include a botnet detection system 150, network computers 180, a corporate LAN 160, an optional network management computer 170, an optional internet firewall 120 and the Internet 110. In an example embodiment, the botnet detection system 150 may include a management port 152, a LAN port 154, and a WAN port 156. The configuration shown in FIG. 1 illustrates an inline mode of operation, in which the botnet detection system 150 is located in between the Internet and the corporate LAN 160. In other words, all the traffic between the Internet and the corporate LAN 160 has to pass through the botnet detection system 150.

According to example embodiments, the botnet detection system 150 may be connected to the Internet via a WAN port 156. The link between the corporate LAN 160 and the Internet is provided by the botnet detection system 150 through the LAN port 154. The corporate LAN 160, network computers 180 and the optional network management computer 170 may be protected by the botnet detection system 150. The botnet detection system 150 may monitor the activities associated with the network computers 180 through the LAN port 154 and the WAN port 156. The botnet detection system 150 may detect bot activities associated with the network computers 180 and attribute bot statuses to the network computers 180, based on the bot activity types (e.g., botnet control, IP scanning, spamming, DDoS attack, and spyware activities).

In example embodiments, the botnet detection system 150 may update the bot statuses associated the network computers 180, based on the bot activity types associated with the subsequent bot activities and one or more other criteria. The bot status associated with network computers 180 may include suspect, active, inactive or clean.

According to example embodiments, the botnet detection system 150 may record timestamps (e.g., time of occurrence) associated with one or more bot activities of the network computers 180. The one or more other criteria used by the botnet detection system 150 may include the timestamps associated with the subsequent bot activities, detected by botnet detection system 150. In example embodiments, the network activities associated with the network computers 180 may include network transmissions and network behavioral patterns. However, the botnet detection system 150 may not install any software on the network computers 180 or use any software already installed on the network computers 180, in order to detect botnet activities.

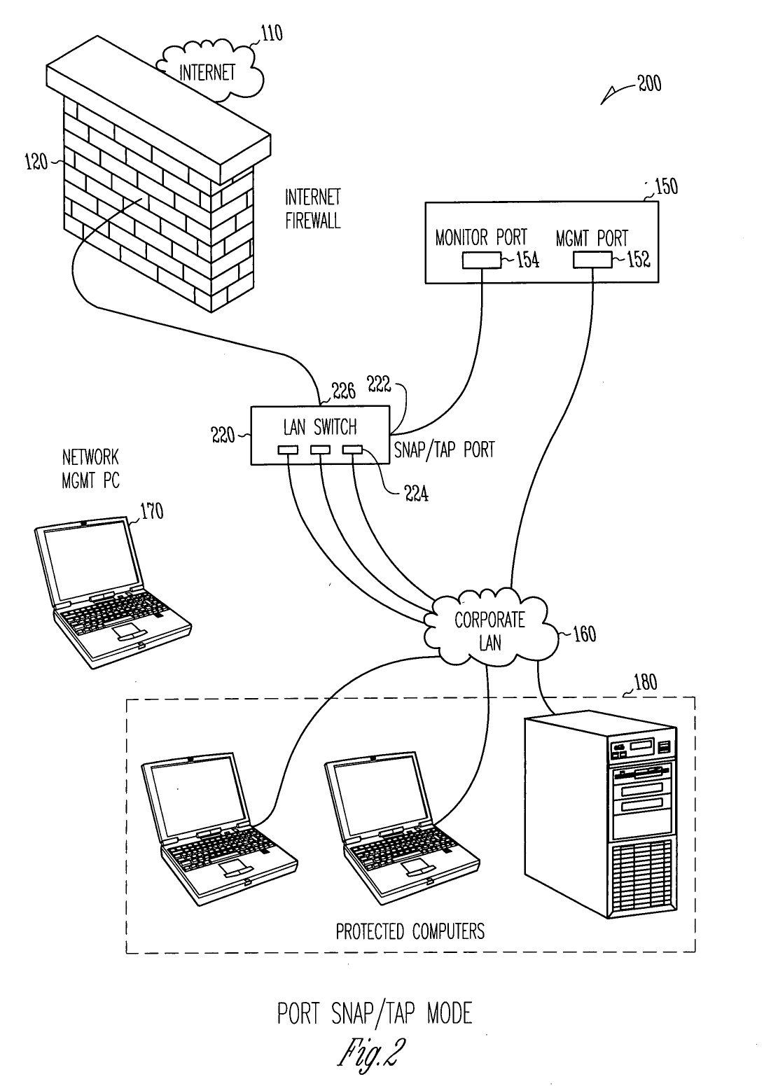

FIG. 2 is a high level block diagram illustrating an example embodiment of a Port Span/Tap operation mode of a system 200 for detecting botnets in a corporate LAN linked to the Internet. In the example port span/tap mode operation illustrated in FIG. 2, the network computers 180 and the optional network management computer 170 may be linked through the corporate LAN 160 and may be connected to the Internet via a LAN switch or hub 220 and optionally protected by the Internet firewall 120. The LAN switch or hub 220 may be connected to the Internet through the connection port 226 and to the corporate LAN 160 through the connections port 224. The LAN switch or hub 220 is capable of providing a copy of the corporate LAN network 160 traffic over a port span/tap 222.

In the example configuration shown, the botnet detection system 150 may be connected through a connection between the LAN port 154 and the port span/tap 222 on the LAN switch or hub 220. This configuration may be advantageous in the sense that the botnet detection system 150, may inspect all traffic between/from/to the network computers 180, while not being in the way of the traffic, therefore, not affecting the corporate LAN 160 throughput and connection speed by introducing additional latency.

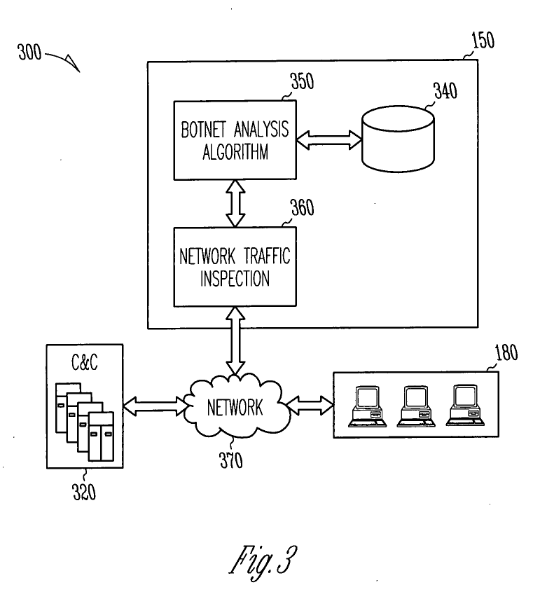

FIG. 3 is a block diagram illustrating an example embodiment of a connection configuration 300 and internal units of botnet detection system 150. In the shown configuration 300, the botnet detection system 150 may be linked to the network computers 180 and the command and control computers 320 via a network 370. In example embodiment, the network 370 may be an internal network of a business enterprise, a corporation or a university etc.

The command and control computers 320 may include the controlling computers of a botnet. The example botnet detection system 150 may include analysis unit 350 including a botnet analysis algorithm. In example embodiments, the botnet detection system 150 may also include a network traffic inspection unit 360 and a database 340. The network traffic inspection unit 360 may inspect all network traffic passing through the network 370 and report data including bot activities to the analysis unit 350. The analysis unit 350 may analyze the received traffic data from the network traffic inspection unit 360 using a botnet analysis algorithm described in more detail below.

The analysis unit 350 may retrieve data related to previous botnet activities from the database 340 or may store current traffic data reported by the network traffic inspection unit 360 or the results of analyses performed by the botnet analysis algorithm. The analyses may be related to botnet activities and bot statuses of the network computers 180. The botnet detection system 150 may consider any contact, via the network 370, between the network computers 180 and the command and control computers 320, or other network transmissions from computers in the network computers 180, and the timestamps associated with the contacts as one of the criteria used for updating the bot status of any network computers.

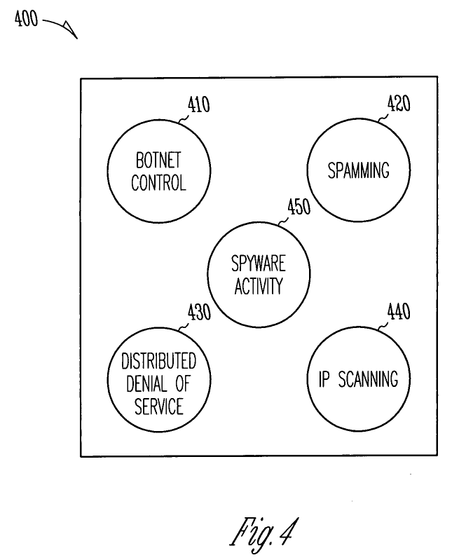

FIG. 4 is a diagram illustrating example activity types 400 of bot activities considered as typical characteristics of bot behavior. The example activity types 400 shown in FIG. 4 may include botnet control 410, spamming 420, Distributed Denial of Service (DDoS) 430, IP scanning 440, and spyware activity 450.

In an example embodiment, the botnet control 410 may include any contact between the network computers 180 and the command and control computers 320. Examples for a contact between the botnet control 410 and the network computers 180 may include network protocol elements such as TCP SYN (Transport Control Protocol Synchronization packet), certain content of the network transmissions and data payload between the botnet control 410 and the network computers 180, and so force. At any time that any one of the network computers 180 makes an attempt to contact any of the command and control computers 320, via the network 370, the network traffic inspection unit 360 may pass the information to the analysis unit 350 which may report a botnet control 410, associated with that computer of the network computers 180. The analysis unit 350 may record the incidents of that botnet control activity and a timestamp associated with that on the database 340. The botnet analysis algorithm included in the analysis unit 350 may use that record to decide about the bot status of the network computer involved in that activity.

The spamming 420 traffic may be detected by the network traffic inspection unit 360 and passed on to the analysis unit 350. The analysis unit 350 may detect that one of the network computers 180 may be engaged in spamming (e.g. sending emails to a typically large number of mail servers). A network computer 180 may be detected by the analysis unit 350 to be involved in a distributed denial of service 430 if the computer attempted a denial of service attack on a web server or other computers in the network. The network traffic inspection unit 360 may report the events to the analysis unit 350. The analysis unit 350 may use the event and the timestamp of the event in the botnet analysis algorithm included in the analysis unit 350 to define a bot status associated with the network computer involved in that event.

In an IP scanning 440, a network computer 180 may be involved in scanning other computers in the network. The network traffic inspection unit 360 may keep track of such an activity and report the activity to the analysis unit 350. The analysis unit 350 may record the incidence of IP scanning 440 associated with the network computer and a timestamp associated with that event on the database 340. The botnet analysis algorithm included in the analysis unit 350 may use the IP scanning 440 event and the timestamp associated with that event in deciding the bot status of that network computer. The network traffic inspection unit 360 may report a spyware activity 450 if a spyware activity (such as active spyware infection or malware file downloads) was detected on one of the network computers 180.

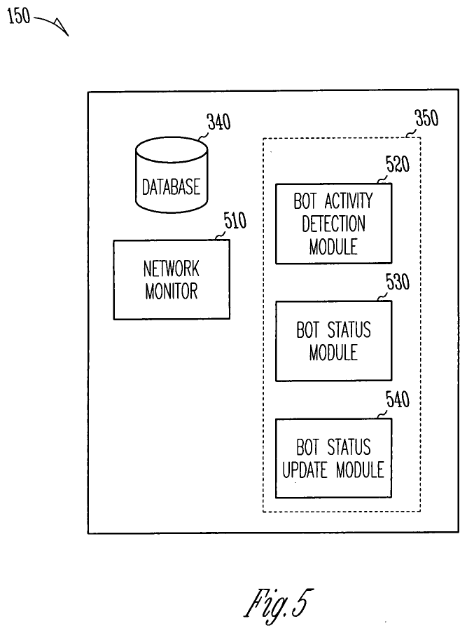

FIG. 5 is a diagram illustrating an example embodiment of various module of a botnet detection system 150. The example botnet detection system 150 may include the analysis unit 350, the network monitor 510, and the database 340. The analysis module may include a bot activity detection module 520, and a bot status module 530, and a bot status update module 540.

According to an example embodiment, the network monitor 510 may monitor the network activities associated with the network computers 180 connected to the network 370. In an example embodiment, the bot activity detection module 520 may detect that any of the network computers 180 may be involved in a bot activity including botnet control 410, spamming 420, distributed denial of service 430, IP scanning 440, or spyware activity 450.

In one example embodiment, if one of the network computers 180 engage in a subsequent bot activity, the bot status update module 540 will update the bot status attributed to that computer, based on detection of subsequent bot activities associated with that computer, by the bot activity detection module 520, the bot activity type of that subsequent bot activity, and one or more other criteria including the timestamp associated with that event.

### Flow Diagrams

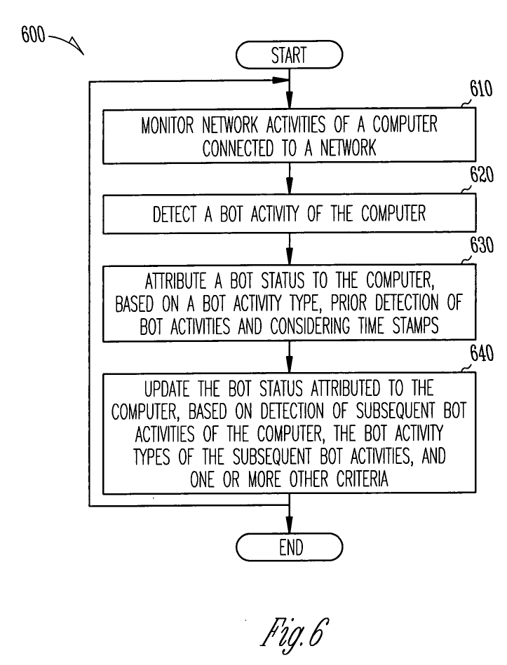

FIG. 6 is a flow diagram illustrating an example embodiment of a method 600 for network monitoring and botnet detection. In one example embodiment, the method 600 may start at operation 610 where the network activities of the network computers 180, linked to the network 370, may be detected by the network monitor 510. At operation 620, the bot activity detection module 520 may detect bot activities associated with one of the computers belonging to the network computers 180. At operation 630, the bot status module may attribute a bot status to the computer involved in that bot activity based on the bot activity type that the computer engaged in, prior detection of bot activities and considering time stamps.

In example embodiments, the bot activities may include botnet control 410, spamming 420, distributed denial of service 430, IP scanning 440, and spyware activity 450, while detecting such activities, the timestamp at the detection time is recorded. The bot status update module 540, at operation 640, may update the bot status attributed to the network computer 180, upon detection by the bot activity detection module 520, that the computer was involved in a subsequent bot activity, based on the bot activity type of the subsequent bot activities and one or more other criteria including a timestamp recorded for that subsequent bot activity.

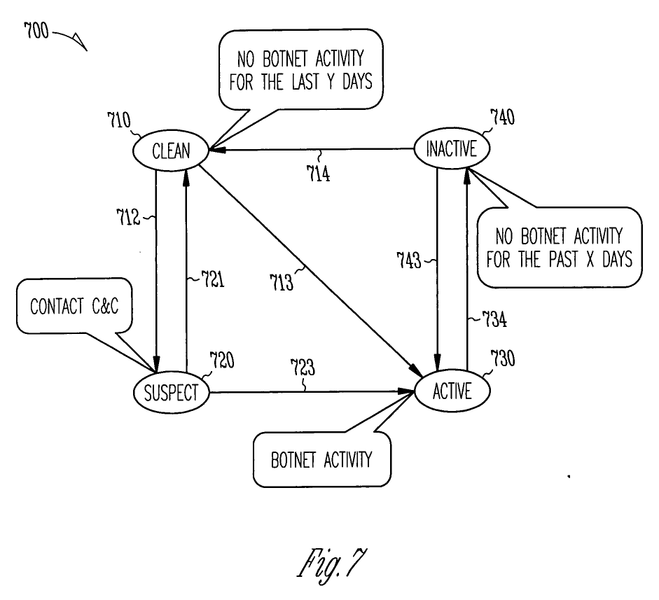

FIG. 7 is a flow diagram illustrating an example embodiment of algorithm 700 for defining various bot statuses and inter-status transitions. In an example embodiment, the algorithm 700 may define four distinguished bot statuses including, a clean status 710, a suspect status 720, an active status 730, and an inactive status 740.

The bot status module 530 may change the status of a clean computer 710 to the suspect status 720 (transition 712) upon detection by a network monitor 5 10 that the clean computer has been involved in a contact with a command and control computer 320 of a botnet. In other words, if a clean computer is detected to be engaged in a botnet control activity, the status of that computer may change to that of the suspect status 720.

The bot status module 530 may change the suspect status 720 of a network computer 180 to the active status 730, if the bot activity detection module 520 detects another bot activity including botnet control 410, spamming 420, distributed denial of service 430, or IP scanning 440 by that network computer. The change of status from suspect status 720 to active status 730 is indicated by the transition 723.

The bot status update module 540 may cause a transition 734 of status of a network computer 180, from the active status 730 to the inactive status 740, if the network computer was not detected, by the network monitor 510 to be involved in any bot activity for the past predefined time duration, e.g. five days.

The status of an inactive network computer may switch through the transition 714, by the bot status update module 540, to the clean status 710, if that computer was not involved in any botnet activity for the last predefined time period, e.g. 90 days; or another longer time period, e.g., 120 days, if the last immediate activity was a botnet control activity.

The bot status of a clean computer may be changed by the bot status module 530 to the active status 730 through a transition 713 if two different subsequent botnet activities including botnet control 410, spamming 420, distributed denial of service 430, or IP scanning 440 occur within a predefined time window. The status of a suspect computer may switch to the clean status 710, by the bot status update module 540, via transition 721, if that computer was not engaged in any further botnet activities within a predefined time window, e.g. 120 days.

An inactive computer may make a transition 743 by the bot status module 530, to the active status 730 if that computer was detected, by the network monitor 510, to be involved in a botnet activity including botnet control 410, spamming 420, distributed denial of service 430, or IP scanning 440.

### Machine Architecture

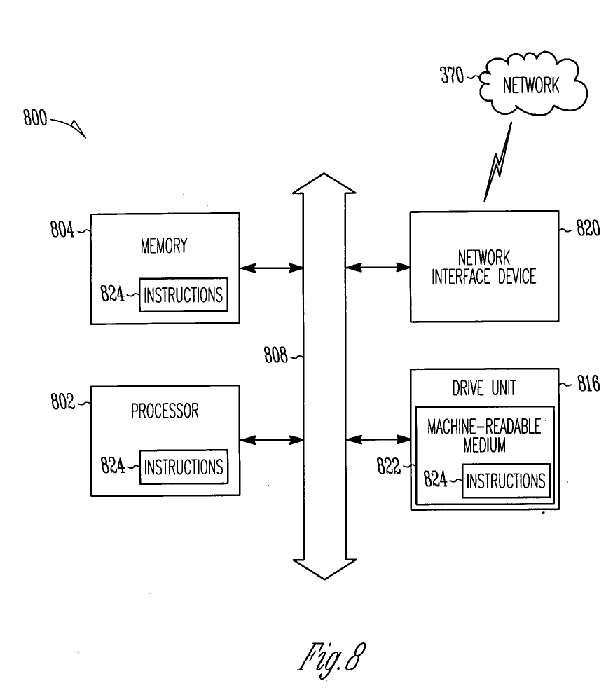

FIG. 8 shows a diagrammatic representation of a machine in the example form of a computer system 800 within which a set of instructions, for causing the machine to perform any one or more of the methodologies discussed herein, may be executed. In alternative embodiments, the machine may operate as a standalone appliance device or may be connected (e.g., networked) to other machines. In a networked deployment, the machine may operate in the capacity of a standalone gateway appliance, a server or a client machine in server-client network environment, or as a peer machine in a peer-to-peer (or distributed) network environment. The machine may be a personal computer (PC), a tablet PC, a set-top box (STB), a Personal Digital Assistant (PDA), a cellular telephone, a Web appliance, a network router, switch or bridge, or any machine capable of executing a set of instructions (sequential or otherwise) that specify actions to be taken by that machine. Further, while only a single machine may be illustrated, the term “machine” shall also be taken to include any collection of machines that individually or jointly execute a set (or multiple sets) of instructions to perform any one or more of the methodologies discussed herein.

The example computer system 800 includes a processor 802 (e.g., a central processing unit (CPU), a graphics processing unit (GPU) or both), a memory 804 which communicate with each other via a bus 808. The computer system 800 may include a network interface device 820.

The disk drive unit 816 may include a machine-readable medium 822 on which is stored one or more sets of instructions and data structures (e.g., software 824) embodying or utilized by any one or more of the methodologies or functions described herein. The software 824 may also reside, completely or at least partially, within the memory 804 and/or within the processor 802 during execution thereof by the computer system 800, the memory 804 and the processor 802 also constituting machine-readable media.

The software 824 may further be transmitted or received over a network 370 via the network interface device 820 utilizing any one of a number of proprietary or well-known transfer protocols (e.g., HTTP).

While the machine-readable medium 822 is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that may be capable of storing, encoding, or carrying a set of instructions for execution by the machine and that cause the machine to perform any one or more of the methodologies of the present invention, or that may be capable of storing, encoding or carrying data structures utilized by or associated with such a set of instructions. The term “machine-readable medium” shall accordingly be taken to include, but not be limited to, solid-state memories, optical and magnetic media, and carrier wave signals.

Thus, a method and system to provide monitoring network activities associated with a computer connected to a network are provided. Although the present invention has been described with reference to specific example embodiments, it will be evident that various modifications and changes may be made to these embodiments without departing from the broader spirit and scope of the invention. Accordingly, the specification and drawings are to be regarded in an illustrative rather than a restrictive sense.

The Abstract of the Disclosure is provided to comply with 37 C.F.R. §1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separate embodiment.

What is claimed is:

1. A method comprising:
monitoring network activities associated with a computer connected to a network;
detecting a bot activity associated with the computer;
attributing a bot status to the computer, based on a bot activity type associated with the bot activity, prior detections of bot activities, and considering time stamps; and
updating the bot status attributed to the computer, based on detection of subsequent bot activities associated with the computer, the bot activity types associated with the subsequent bot activities, and at least one other criterion.

2. The method of claim 1, wherein the network activities include network transmissions and network behavioral patterns.

3. The method of claim 1, wherein monitoring the network activities is performed from within the network.

4. The method of claim 1, further comprising recording timestamps associated with the subsequent bot activities.

5. The method of claim 5, wherein the at least one other criterion includes the timestamps associated with the subsequent bot activities.

6. The method of claim 1, wherein the bot status includes at least one of a suspect, an active, an inactive, or a clean.

7. The method of claim 1, wherein the bot activity type includes at least one of:
a botnet control,
an Internet Protocol (IP) scanning,
a spamming, or
a Distributed Denial of Service (DDoS) attack.

8. The method of claim 1, wherein updating the bot status attributed to the computer is performed using a long-term memory algorithm.

9. The method of claim 2, wherein the behavioral patterns include a behavioral pattern mixed with a signature.

10. A system comprising:
a network monitor to monitor network activities associated with a computer connected to a network;
a bot activity detection module to detect a bot activity associated with the computer;
a bot status module to attribute a bot status to the computer, based on a bot activity type associated with the bot activity, prior detections of bot activities, and considering time stamps;
the bot activity detection module to detect subsequent bot activities associated with the computer; and
a bot status update module to update the bot status attributed to the computer, based on detection of the subsequent bot activities associated with the computer, the bot activity types associated with the subsequent bot activities, and at least one other criterion.

11. The system of claim 10, wherein the network monitor is to monitor network activities including network transmissions and network behavioral patterns.

12. The system of claim 10, wherein the network monitor is to monitor the network activities from within the network.

13. The system of claim 10, wherein the at least one other criterion used by the bot status module includes the timestamp associated with the subsequent bot activities.

14. The system of claim 10, wherein the bot status module is to attribute the bot status, the bot status including at least one of a suspect, an active, an inactive, or a clean.

15. The system of claim 10, wherein the bot activity detection module is to detect the bot activity type, the bot activity type including at least one of:
a botnet control,
an Internet Protocol (IP) scanning,
a spamming, or
a Distributed Denial of Service (DDoS) attack.

16. The system of claim 10, wherein the bot status update module is to update the bot status attributed to the computer using a long-term memory algorithm.

17. The system of claim 10, wherein the bot status includes at least one of a suspect, an active, an inactive, or a clean.

18. A system comprising:
means for monitoring network activities associated with a computer connected to a network;
means for detecting a bot activity associated with the computer;
means for attributing a bot status to the computer, based on a bot activity type associated with the bot activity, prior detections of bot activities, and considering time stamps;
means for detecting subsequent bot activities associated with the computer; and
means for updating the bot status attributed to the computer, based on detection of the subsequent bot activities associated with the computer, the bot activity types associated with the subsequent bot activities, and at least one other criterion.

19. The system of claim 18, further comprising means for recording timestamps associated with the subsequent bot activities.

20. A machine readable medium comprising instructions, which when implemented by one or more processors perform following operations:
monitor network activities associated with a computer connected to a network;
detect a bot activity associated with the computer;
attribute a bot status to the computer, based on a bot activity type associated with the bot activity, prior detections of bot activities, and considering time stamps;
detect subsequent bot activities associated with the computer; and
update the bot status attributed to the computer, based on detection of the subsequent bot activities associated with the computer, the bot activity types associated with the subsequent bot activities, and at least one other criterion.
